(19) United States
(12) Patent Application Publication
(10) Pub. No.: US 2013/0179271 A1
(43) Pub. Date: Jul. 11, 2013

(54) Grouping and Ordering Advertising Units Based on User Activity

(71) Applicants: Paul Adams, San Francisco, CA (US); Carol Chia-Fan Pai, Santa Clara, CA (US)

(72) Inventors: Paul Adams, San Francisco, CA (US); Carol Chia-Fan Pai, Santa Clara, CA (US)

(21) Appl. No.: 13/348,491

(22) Filed: Jan. 11, 2012

(51) Int. Cl. G06Q 30/02

(52) U.S. Cl. 705/14.66

(57) ABSTRACT

A viewing user is provided with an ordered group of advertising units when accessing content associated with a social networking system. Each of the advertising units can be related to a user activity, where the user activity is performed at least by the viewing user or a friend of the viewing user. The advertising units can be ordered using a sales funnel. In particular, the sales funnel may include a number of different positions. Each advertising unit can be assigned to a position in the sales funnel. Based on each advertising unit's position in the sales funnel, an ordering for the advertising units can be determined. The ordering can be used to place the advertising units on a web page requested by the viewing user.

### BACKGROUND

This invention generally pertains to social networking, and more specifically to providing an ordered grouping of advertising units, for display, to a viewing user.

Social networks, or social utilities that track and enable connections between users (including people, businesses, and other entities), have become prevalent in recent years. In particular, social networking systems allow users to communicate information more efficiently. For example, a user may post contact information, background information, job information, hobbies, and/or other user-specific data to a location associated with the user on a social networking system. Other users can then review the posted data by browsing user profiles or searching for profiles including specific data. The social networking systems also allow users to associate themselves with other users, thus creating a web of connections among the users of the social networking system. These connections among the users can be exploited by the social networking system to offer more relevant information to each user in view of the users' own stated interests.

Social networking systems typically incorporate a system for connecting users to content that is most likely to be relevant to each user. For example, users may be grouped according to one or more common attributes in their profiles, such as geographic location, employer, job type, age, music preferences, interests, or other attributes. Users of the social networking system or external parties can then use these groups to customize or target information delivery so that information that might be of particular interest to a group can be communicated to that group.

Advertisers have attempted to leverage this information about members by targeting their ads to members whose interests best align with the ads. For example, a social networking system may display banner ads for a concert to members who include an affinity for the performing band in their social networking system profile and live near a concert venue where that band might be performing. However, these attempts are no different than targeting of ads that exist in many other contexts. Advertisers have not yet been able to exploit the relationships and connections among members of a social networking system in a meaningful way to increase user engagement with an advertisement, advertised product, or brand.

### SUMMARY

Embodiments of the invention provide an ordered group of advertising units for display to a viewing user of a social networking system. Each advertising unit can be related to a user activity performed by at least the viewing user or a friend of the viewing user. For example, a friend of the viewing user may have “liked” a particular television show episode. A first advertising unit in the group may include a link to a fan page of an actor featured in the episode. A second advertising unit in the group may include a trailer for a movie also featuring the actor.

In one embodiment, the advertising units in the group are ordered according to a sales funnel. In particular, the sales funnel may include a number of ordered positions or categories. Each advertising unit may be assigned to a particular position in the sales funnel based on a type for the advertising unit. For example, a first advertising unit may be considered a discovery type because the advertising unit introduces an item of content associated with the user activity. A second advertising unit may be considered a discussion type because the advertising unit includes an input element that enables a user to provide a comment. The two advertising units may be assigned to different positions in an associated sales funnel. By assigning advertising units to various positions within a sales funnel, an ordering for the advertising units can be determined. The determined ordering for the advertising units may subsequently be used to place or arrange the advertising units on a web page. In using the ordering, embodiments of the invention enable a web page to present the group of advertising units in an order that makes the group more likely to engage with a viewing user.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a diagram of a process for providing an ordered group of advertising units to a user of a social networking system, in accordance with an embodiment of the invention.

FIG. 2A is a high level block diagram illustrating a system environment suitable for operation of a social networking system, in accordance with an embodiment of the invention.

FIG. 2B is a block diagram of various components of a social networking system, in accordance with an embodiment of the invention.

FIG. 3A illustrates a schematic of an exemplary web page that includes a group of ordered advertising units, in accordance with an embodiment of the invention.

FIG. 3B illustrates an exemplary web page that includes a group of ordered advertising units, in accordance with an embodiment of the invention.

FIG. 4 is a flow chart of a process for providing an ordered group of advertising units to a user of a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the system. In use, users join the social networking system and then add connections to a number of other users to whom they desire to be connected. As used herein, the term “friend” refers to any other user to whom a user has formed a connection, association, or relationship via the system. Connections may be added explicitly by a user, for example, the user may select a particular other user to be a friend, or may be automatically created by the social networking site based on common characteristics of the users (e.g., users who are alumni of the same educational institution). Connections in social networking systems are usually in both directions, but need not be, so the terms “user” and “friend” depend on the frame of reference. For example, if Bob and Joe are both users and connected to each other in the system, Bob and Joe are also each other's friends. The connection between users may be a direct connection; however, some embodiments of a social networking system allow the connection to be indirect via one or more levels of connections. Also, the term friend need not require that users actually be friends in real life, (which would generally be the case when one of the users is a business or other entity); it simply implies a connection in the social networking system.

In addition to interactions with other users, the social networking system provides users with the ability to perform various types of activities with social networking objects supported by the system. A social networking object can represent a variety of things, including, without limitation, profiles, applications (e.g., games playable within the social networking system), events (e.g., a page representative of a concert that users may attend), groups (e.g., a page to which user may belong), entity based pages or hubs (e.g., a page constituting a particular entity's presence on the social networking system), locations associated with a user (e.g., “Palo Alto, Calif., USA”), advertisements (e.g., a page including advertising content), user-generated content items (e.g., user posts), representations of physical or digital items, concepts, etc. A user can interact with a social networking object by associating with the object or performing an action on the object. For example, a user can interact with an object by joining a group, attending an event, checking-in to a location, becoming a fan of an organization's fan page, “liking” a fan page, posting to a fan page, etc. These are just a few examples of the objects upon which a user may act on in a social networking system, and many others are possible.

In one embodiment, a social networking system provides an ordered group of advertising units for display to a viewing user. Each advertising unit in the group can include various types of content. For instance, an advertising unit can include text (e.g., a statement describing a user activity, a product description, etc.), media, organic content (e.g., user generated content), advertising content (e.g., advertisements received from advertisers), event information, purchase information, input elements, applications, links (e.g., universal resource identifiers), etc. For example, an advertising unit may include content describing an activity performed by a friend of the viewing user. As another example, an advertising unit may include an advertisement for a product. As still another example, an advertising unit may include a trailer for a movie and an input element enabling the viewing user to provide a comment regarding the trailer.

In some instances, each advertising unit in a group is related to a user activity performed by a friend of the viewing user. For example, a friend of the viewing user may have “liked” a particular movie. The group of advertising units provided to the viewing user may each be related to the movie. In other instances, each advertising unit in a group is related to an activity performed by the viewing user. For example, the viewing user may have “checked-in” or otherwise indicate that he or she is at a particular location. The group of advertising units provided to the viewing user may each be related to the location. In still other instances, each advertising unit in a group is related to an activity performed by both the viewing user and a friend of the viewing user. For example, both the viewing user and his or her friend may have “liked” the fan page of a particular computer company. The group of advertising units provided to the viewing user may each be related to the fan page.

An advertising unit in a group may be related to a user activity in any suitable manner. In one embodiment, an advertising unit is related to an activity if the advertising unit is associated with a social networking object involved in the activity. For example, an activity may involve a friend of the viewing user “liking” a particular television show episode. A related advertising unit may include content describing other friends of the viewing user who have “watched” the same television show episode. A different related advertising unit may include a synopsis for the television show episode, a trailer for the episode, user generated comments regarding the episode, a link to a page for an actor featured in the episode, etc.

In one embodiment, the kinds of advertising units presented to the viewing user can depend on the specific user activity with which the advertising units are related. For example, a friend of the viewing user may have “liked” a movie. Advertising units related to the movie may include content describing other friends of the viewing user who have liked the movie, a trailer for the movie, and local show times for the movie. As another example, a friend of the viewing user may have “listened” to a recently released song. The advertising units related to the song may be of different kinds than the advertising units related to the movie in the previous example. For instance, the advertising units related to the song may include content suggesting similar songs, information indicating that one of the viewing user's friends is attending a concert for the artist of the song, purchase information for tickets to the concert, etc.

In one embodiment, each advertising unit in a group is ordered according to a sales funnel. In particular, each advertising units may be assigned a particular sales funnel type. The sales funnel type for each individual advertising unit can be based on the content for the advertising unit and the role the content plays in a sales funnel. In one embodiment, the advertising units may be assigned to have either a discovery type, a common ground type, a discussion type, or an event type.

Advertising units classified as the discovery type can include content identified as generally enabling a viewing user to discover content related to a user activity. For example, a user activity may involve a friend “liking” a particular artist. An advertising unit having the discovery type may include content for a song by the artist (e.g., an audio clip of the song, a link to the lyrics of the song, etc.). As another example, a user activity may involve a friend commenting on the fan page of a particular company. An advertising unit having the discovery type may include content describing a new product recently introduced by the company.

Advertising units classified as the common ground type can include content describing a user activity performed by both the viewing user and a friend of the viewing user. For example, both a viewing user and his or her friend may have “liked” the same movie. An advertising unit have the common ground type may include content indicating that both the viewing user and the friend have “liked” the movie.

Advertising units classified as the discussion type can include content that enables a discussion or conversation to be started and/or spread over the social networking system. More specifically, such advertising units may enable a user to interact with content related to a user activity. For example, a friend of the viewing user may have “liked” a particular television show. An advertising unit having a discovery type may include a link to a fan page of an actor featured in the show. An advertising unit having a discussion type may include a trailer for a movie featuring the actor and an input element enabling a viewing user to provide comments regarding the actor's performance in the movie. Any suitable type of input elements can be included in advertising units having the discussion type. For example, an input element can be a text box, button, set of radio buttons, a dropdown menu, etc. Advertising units having the discussion type can additionally include one or more questions that may be answered via the input elements. For example, an advertising unit having the discussion type can include a question asking for the viewing user's opinion on a particular movie. The advertising unit can additionally include a text box with which the viewing user can interact to answer the question. The information provided by the viewing user via an input element can be used to distribute stories regarding the viewing user's interaction with the input element to the viewing user's friends. Groups of advertising units related to the stories may also be distributed to the viewing user's friends. In doing so, embodiments can enable the viral distribution of advertising units.

Advertising units classified as the event type can include content describing events related to a user activity. An event can be any suitable occurrence, such as a concert, a performance, a showing, a broadcast (e.g., a television broadcast or an online stream), a planned event, a party, a meeting, etc. For example, a friend of the viewing user may have “liked” a particular musical artist. An advertising unit associated with the event type may include information for an upcoming concert featuring the artist. The information may include the date and times for the event, and a link to a website from which tickets for the concert may be purchased. As another example, a friend of the viewing user may have “watched” a particular movie. An advertising unit associated with the event type may include a time that certain friends of the viewing user are planning on watching the movie.

In one embodiment, the sales funnel used to order a group of advertising units can include a number of different ordered positions, where each position corresponds to a particular sales funnel type. In one aspect, each of the advertising units in a group can be distributed to a particular position in the sales funnel based on the unit's assigned sales funnel type. In doing so, an ordering for the advertising units can be determined. In one embodiment, the ordering for the advertising units can be based on a logical sales progression. For example, the advertising units may be ordered in descending order of specificity. Illustratively, advertising units ordered first may generally introduce content related to a user activity. Following advertising units may provide more specific content, interaction opportunities, and optionally purchase information for related items, related events, etc. Illustratively, a friend of the viewing user may have “liked” a particular television show episode. An advertising unit ordered first may indicate that another friend of the viewing user has “liked” an actor featured in the television show episode. An advertising unit ordered second may include a movie trailer featuring the actor. The advertising unit ordered second may additionally include an input element enabling the viewing user to post a comment regarding the trailer. An advertising unit ordered third may include show times for the movie featuring the actor and a link to a website where tickets for the movie can be purchased.

As discussed, advertising units, in one embodiment, can either have a discovery type, common ground type, discussion type, or event type. In the embodiment, advertising units having the discovery type can be ordered before advertising units having the common ground type in a sales funnel. Advertising units having the common ground type can be positioned before advertising units having the discussion type in the sales funnel. Advertising units having the discussion type can be positioned before advertising units having the event type in the sales funnel. Other embodiments may include additional, fewer, and/or different sales funnel types. Such embodiments may position various sales funnel types differently in a sales funnel.

In one embodiment, the advertisements can be placed or arranged on a web page (e.g., a user profile page of the social networking system, a page including a newsfeed of social networking system content, etc.) according to the determined ordering for the advertised units. The placement of the advertising units can enable a viewing user to logically follow the progression of the sales funnel associated with the advertising units. For example, the advertising units can be vertically arranged such that advertising units ordered higher appear closer to the top edge of the web page. In one embodiment, the advertising units can be arranged such that the viewing user is able to discern that the advertising units are grouped together. For example, the advertising units may each be placed adjacent to one another or in adjacent sections. In one embodiment, the ordered group of advertising units may be displayed on the web page with a story describing the user activity related to the advertising units.

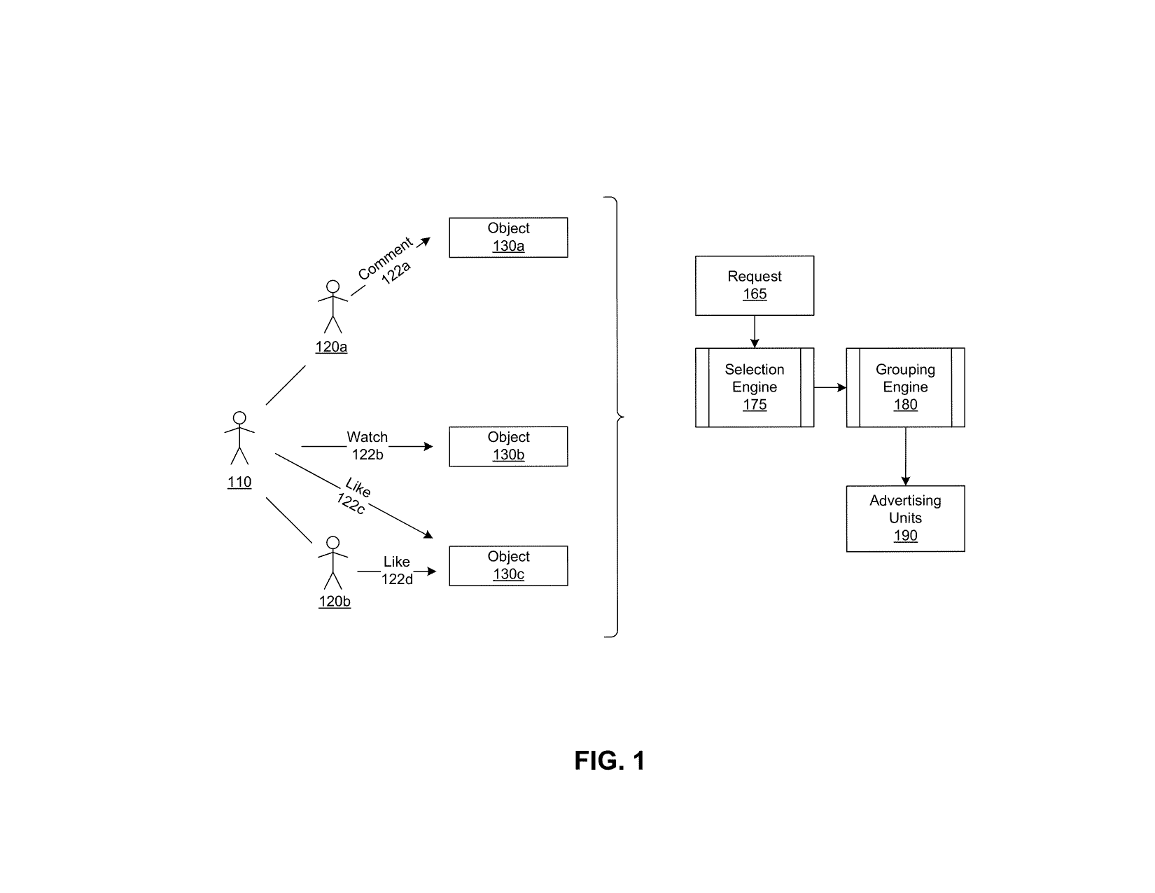

FIG. 1 illustrates a process for providing an ordered group of advertising units. The process begins with a selection engine 175 receiving a request 165 for a group of advertising units. Upon receiving the request, the selection engine 175 selects a user activity to serve as the basis for the selection of the group of advertising units. In particular, the selection engine 175 can identify the user activities performed by the viewing user 110 or the viewing user's friends 120. Referring to FIG. 1, the selection engine 175 may identify the user activities 122. Based on the identified user activities 122, the selection engine 175 selects a specific user activity to serve as the basis for the selection of the group of advertising units. Upon selecting a specific user activity, the grouping engine 180 selects a group of advertising units to be provided for display to the viewing user. An ordering for each of the advertising units can be determined, by the grouping engine 180, according to a sales funnel. The advertising units can thereafter be placed on a web page to be displayed to the user, where the location of each advertising unit is based on the determined ordering. The ordered group of advertising units 190 can thereafter be provided for display to the viewing user. In one embodiment, a story (e.g., a sponsored story, newsfeed story, etc.) including content describing the user activity with which the group of advertising units 190 is related may also be provided for display to the viewing user. Additional details regarding the manner in which an ordered group of advertising units can be provided for display to a viewing user will be described below.

### System Architecture

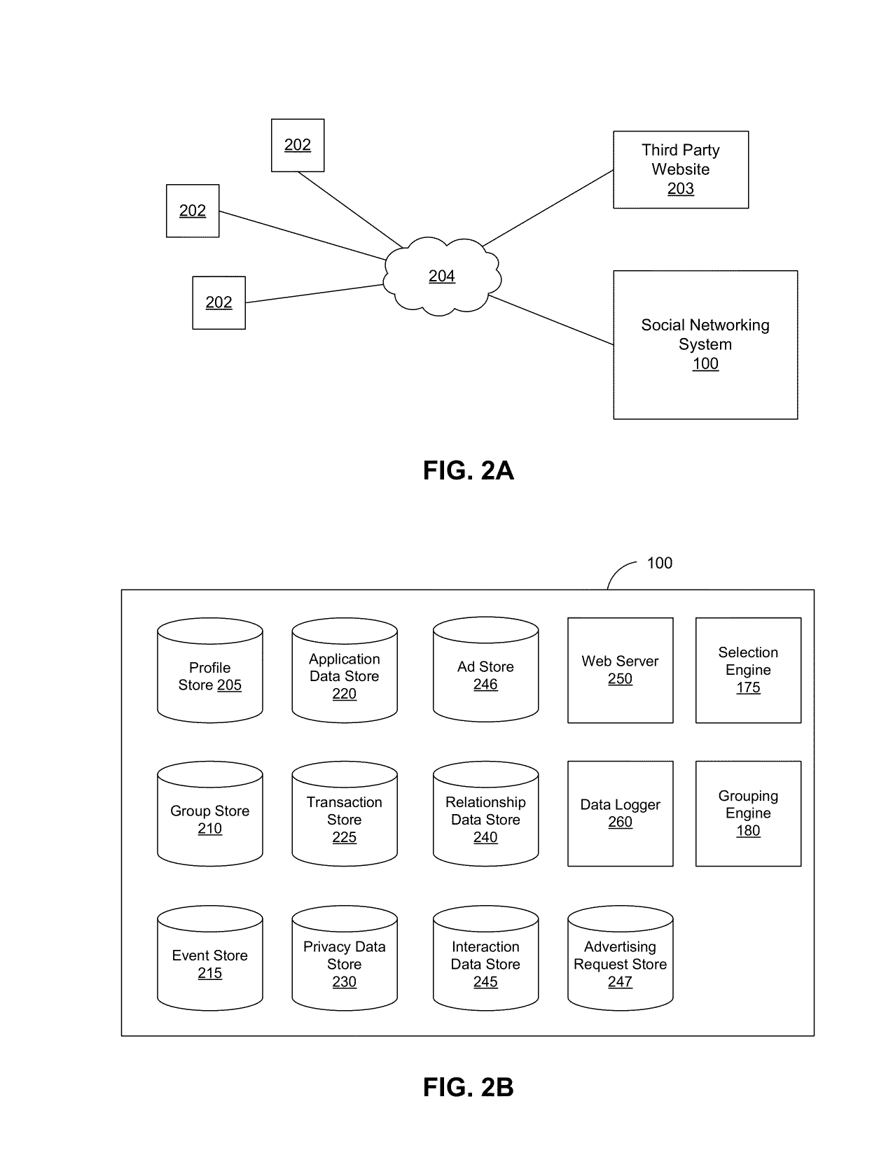

FIG. 2A is a high level block diagram illustrating a system environment suitable for operation of a social networking system 100. The system environment includes one or more client devices 202, one or more third-party websites 203, a social networking system 100, and a network 204. While only three client devices and one third-party website are shown in FIG. 2A, it should be appreciated that any number of these entities (including millions) can be included. In alternative configurations, different entities can also be included in the system.

The network 204, in general, can be any network, including but not limited to any combination of the Internet, a mobile network, a LAN, a wired or wireless network, a private network, and/or a virtual private network.

The client devices 202 include one or more computing devices that can receive user input and can transmit and receive data via the network 204. For example, the client devices 202 may be desktop computers, laptop computers, tablet computers (pads), smart phones, personal digital assistants (PDAs), or any other device including computing functionality and data communication capabilities. The client devices 202 are configured to communicate via network 204, which may include any combination of local area and/or wide area networks, using both wired and wireless communication systems. The client devices 202 can provide a means by which various users can communicate with the social networking system 100. The third party website 203 is coupled to the network 204 in order to communicate with the social networking system 100.

The social networking system 100 includes a computing system that allows users to communicate or otherwise interact with each other and access content as described herein. In one embodiment, the social networking system 100 stores user profiles that describe the users of a social network, including biographic, demographic, and other types of descriptive information, such as work experience, educational history, hobbies or preferences, location, and the like. The social networking system 100 additionally stores other objects, such as fan pages, events, groups, advertisements, general postings, etc.

FIG. 2B is an example block diagram of various components of the social networking system 100. The social networking system 100 includes a web server 250, a data logger 260, a selection engine 175, a grouping engine 180, a profile store 205, a group store 210, an event store 215, an application data store 220, a transaction store 225, a privacy data store 230, a relationship data store 240, an interaction data store 245, an ad store 246, and an advertising request store 247. In alternative configurations, different components can be included in the system 100.

In general, the web server 250 links the social networking system 100 via the network 204 to one or more of the client devices 202, as well as to one or more third party websites 203. The web server 250 may include a mail server or other messaging functionality for receiving and routing messages between the social networking system 100 and the client devices 202 or third party websites 203. The messages can be instant messages, queued messages (e.g., email), text and SMS messages, or any other suitable messaging technique. In one embodiment, the web server 250 can receive user requests for content, where an ordered group of advertising units is to be provided with the content. In response, the web server 250 may send a request for an ordered group of advertising units to the selection engine 175.

The data logger 260 is capable of receiving communications from the web server 250 regarding the different user activities occurring over the social networking system 100. The social networking system 100 can maintain such data in any suitable manner. In one embodiment, each of the profile store 205, the group store 210, the event store 215, the application data store 220, the transaction store 225, the privacy data store 230, the relationship data store 240, the interaction data store 245, the ad store 246, and the advertising request store 247 store data structures to manage the data for each instance of a corresponding type of social networking object maintained by the system 100. The data structures include information fields that are suitable for the corresponding type of object. (For example, the event store 215 contains data structures that include the time and location for an event, whereas the profile store 205 contains data structures with fields suitable for describing a user's profile.). When a new object of a particular type is created, the system 100 initializes a new data structure of the corresponding type, assigns a unique object identifier to it, and begins to add data to the object as needed. This might occur, for example, when a new advertising request is received from an advertiser, where the system 100 would generate a new instance of an advertising request in the advertising request store 247, assign a unique identifier to the advertising request, and populate the advertising request with information for defining an ordered group of advertising units (e.g., a sales funnel specification, etc.).

The selection engine 175 selects an advertising request to serve as the basis for an ordered group of advertising units. In one embodiment, selection of the advertising request can be responsive to a request for advertising units received from the web server 250. For example, the web server 250 may receive a request for content (e.g., a web page) from the client 202. The request may indicate that the content be presented with an ordered group of advertising units. In response to the request, the web server 250 can send a request for an ordered group of advertising units to the selection engine 175.

Responsive to receiving the content request, the selection engine 175 retrieves a number of advertising requests from the advertising request store 247. The advertising requests may have been previously received by the social networking system 100 from advertisers, advertising brokers, and/or the like. Each advertising request can request that an ordered group of advertising units related to a particular user activity be presented. For example, an advertising request can request that an ordered group of advertising units be displayed, where each advertising unit is related to a user interacting (e.g., “liking”, commenting on, etc.) with a particular company's fan page. Each advertising request can additionally include a sales funnel specification. The sales funnel specification can define the number and types of advertising units that are to be included in the ordered group of advertising units. For example, the sales funnel specification may specify that an ordered group of advertising units are to include three advertisements retrieved from the ad store 246 and two items of content describing a friend of the viewing user's activities. The sales funnel specification can additionally define a particular sales funnel to be used to determine an ordering for the group of advertising units. In particular, the sales funnel specification can define the various positions or categories of a sales funnel. Each position can be associated with a specific type of advertising unit. Advertising units can be distributed to the various positions of the sales funnel according to their types. The resulting ordering can be used to place or arrange the group of advertising units on a web page for presentation to the viewing user 110.

Based on the retrieved advertising requests, the selection engine 175 identifies a set of candidate advertising requests. In particular, for each advertising request, the selection engine 175 determines whether at least one of the viewing user 110 or the viewing user's friends 120 have performed the activity specified by the advertising request. Those advertising requests that specify user activities that which the viewing user 110 or the viewing user's friends 120 have performed can be considered candidate advertising requests. For example, an advertising request may specify that a “like” interaction be performed on a particular fan page. The advertising request may be considered a candidate if at least one of the viewing user or the viewing user's friends has “liked” the specified fan page.

After identifying the candidate advertising requests, the selection engine 175 selects a specific advertising request. In particular, for each candidate advertising request, the selection engine 175 identifies one or more advertising units related to the user activity specified by the request. In one embodiment, an identified advertising unit can be related to the specified user activity if the advertising unit includes content associated with or relevant to a social networking object involved in the specified user activity. For instance, a specified user activity may involve a friend of the viewing user “liking” a particular movie. A related advertising unit may describe a user activity involving a user “liking” an actor featured in the movie.

In one embodiment, each identified advertising unit is classified as a particular sales funnel type. For example, an identified advertising unit can be classified as a discovery type, a common ground type, a discussion type, or an event type. It will be appreciated, however, that other advertising unit types may also be used to classify advertising units. Classification of each advertising unit can proceed in any suitable manner. For example, advertising units can be classified based on the content included in the units, etc. Based on the identified advertising units, the selection engine 175 determines, for each candidate advertising request, whether the request is related to a sufficient number of advertising units. In particular, as discussed, the sales funnel specification of each advertising request can define the number and types of advertising units to be presented to the viewing user. The selection engine 175 can determine whether a sufficient number of advertising units of each type has been identified for the advertising request. Those advertising requests with a sufficient number of related advertising units can be included in a subset of candidate advertising requests from which the selection engine 175 selects an advertising request.

Upon identifying the subset of candidate advertising requests, the selection engine 175 selects a specific advertising request from the subset. The selection engine 175 can select the advertising request in any suitable manner. In one embodiment, the selection engine 175 selects the advertising request with the highest expected value. The expected value can be computed as a function of a per-click bid price for the advertising request (as provided by an advertiser) weighted by an estimated probability that at least one advertising unit related to the request will be clicked by the viewing user 110. To estimate the probability that the viewing user 110 will click on an advertising unit, the selection engine 175 computes this probability as a weighted function of the viewing user's affinities for the social networking object involved in the user activity and/or the friend 120 that performed the activity.

After selection of a specific advertising request, the grouping engine 180 selects a group of advertising units to be presented to the viewing user, where each advertising unit is related to the user activity specified by the selected advertising request. The group of advertising units selected by the grouping engine 180 can collectively meet the requirements defined by the sales funnel specification included in the selected advertising request. For example, the sales funnel specification may specify that three advertising units of the discovery type, two advertising units of the discussion type, and one advertising unit of the event type be selected. Based on this, the grouping engine 180 selects a group of advertising units that satisfies the required threshold number of advertising units for each type.

The grouping engine 180 can select each individual advertising unit in any suitable manner. In one embodiment, for each required type of advertising unit, the grouping engine 180 selects the most recently generated advertising units. In another embodiment, for each required type of advertising unit, the grouping engine 180 selects the advertising units with the highest user engagement values. For example, the grouping engine 180 can select the advertising units with which other users have interacted with and/or viewed the most. Illustratively, the grouping engine 180 may select an advertising unit that includes a comment that which other users have viewed a relatively large number of times. In yet another embodiment, for each required type of advertising unit, the grouping engine 180 selects the advertising units associated with the highest friend coefficients. For example, those advertising units that include content generated by friends with whom the viewing user has a high affinity can be selected. The affinity between a friend and the viewing user can be measured based on the number of interactions between the friend and the viewing user. In particular, the greater the number of interactions (e.g., number of posts on one another's profiles, number of exchanged messages, etc.), the higher the affinity.

In one embodiment, the grouping engine 180 orders the selected group of advertising units according to the sales funnel specification included in the advertising request. The sales funnel specification, as discussed, can define a sales funnel with a number of ordered positions or categories. Each advertising unit can be assigned to a particular position in the sales funnel based on the advertising unit's sales funnel type. In this way, an ordering for the advertising units can be determined.

In one embodiment, the sales funnel can provide a logical progression for presenting the selected group of advertising units. Illustratively, a sales funnel can generally specify an ordering that arranges the advertising units based on descending order of specificity. For example, the sales funnel can define that advertising units classified as a discovery type be placed in first position. The sales funnel can additionally define that advertising units classified as a common ground type be placed in a second position. The sales funnel can furthermore define that advertising units classified as a discussion type be placed in a third position. The sales funnel can moreover define that advertising units classified as an event type be placed in a fourth position.

In one aspect, the determined ordering for the advertising units can be used to place or arrange the units on a web page for display to the viewing user. The locations of the advertising units can be such that the viewing user would logically view the advertising units in the order specified by the ordering of the advertising units. In one embodiment, the advertising units can each be included in the web page at the same time. In such an embodiment, the advertising units can be arranged adjacent to one another, or in adjacent sections. Furthermore, at least one of the advertising units can also be adjacent to a story (e.g., a sponsored story, newsfeed story, etc.) describing the user activity to which the advertising units are related.

In one implementation, the advertising units may be positioned in order from top to bottom. More specifically, advertising units ordered higher may be positioned closer to the top edge of the page. In another implementation, advertising units may be positioned in order from left to right. Specifically, advertising units ordered higher may be positioned closer to the left edge of the page. In still another implementation, advertising units may be positioned in order from right to left. In particular, advertising units ordered higher may be positioned closer to the right side of the page. In another embodiment, advertising units may be rotated in a single advertising section of the page. In such an embodiment, those advertising units ranked higher in the ordering may be displayed in the advertising space before advertising units ranked lower in the ordering.

By ordering and positioning a group of advertising units in the manner described herein, embodiments can introduce content to the viewing user and provide, in close proximity, logically arranged information regarding the content. In this way, the viewing user may be more likely to take interest in the content presented by the advertising units. In doing so, the group of advertising units can improve average conversion rates (CR) or click-through rates (CTR) for sponsored content.

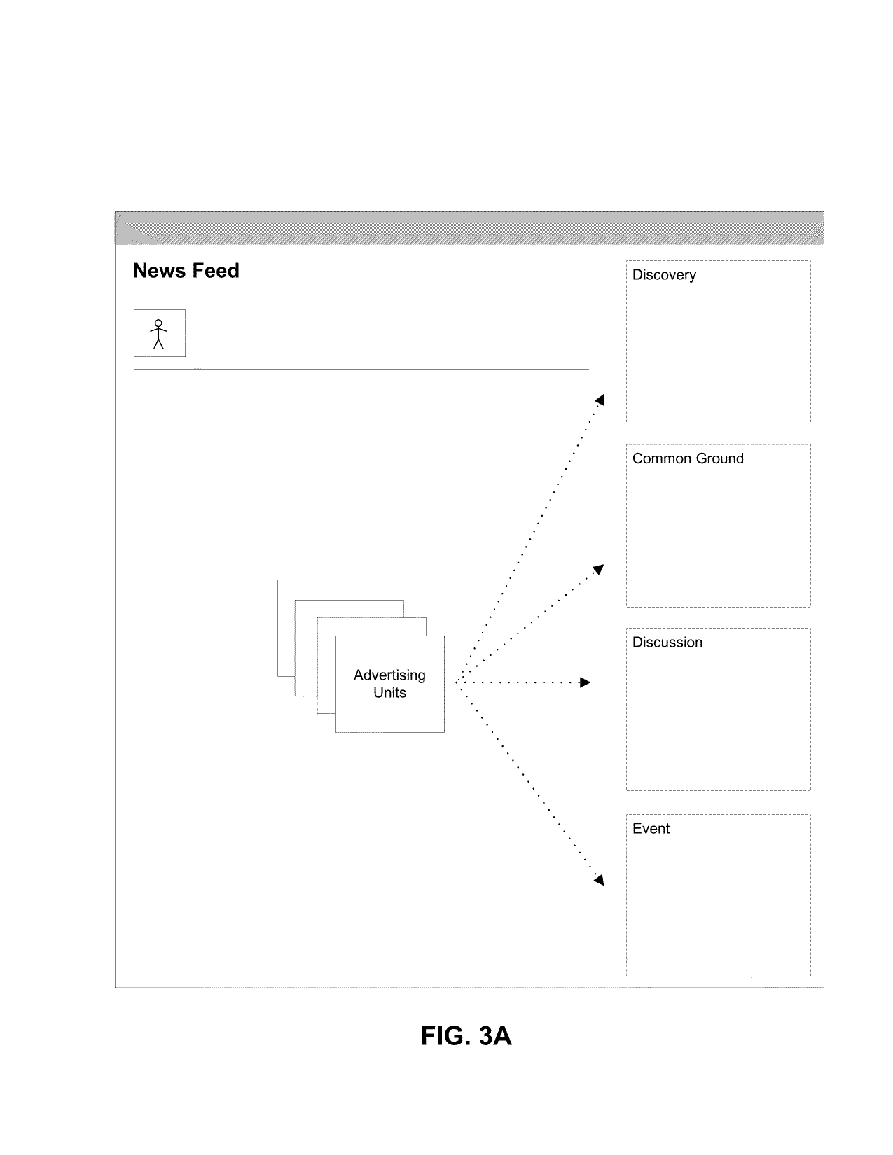

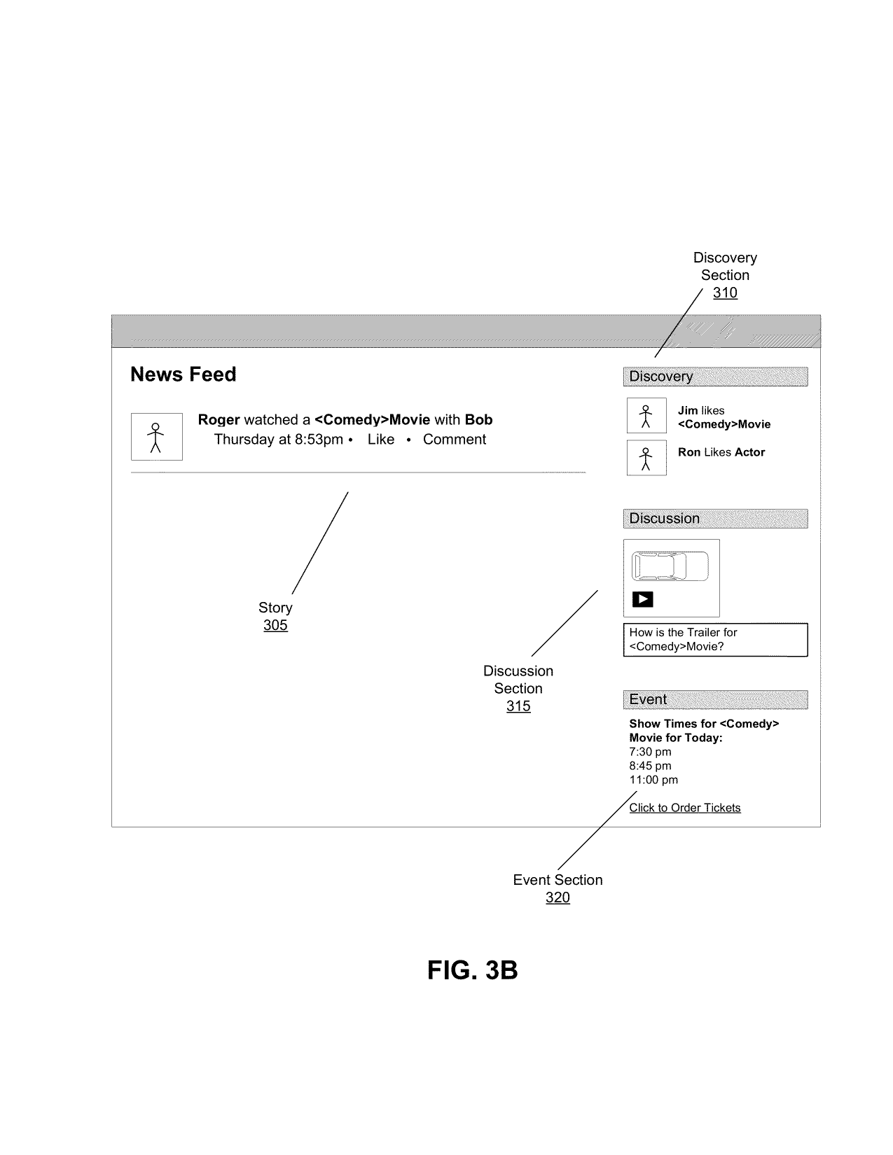

FIG. 3A illustrates a schematic of an exemplary web page that includes an ordered group of advertising units. As shown in FIG. 3A, the group of advertising units can be distributed among one of four different sections in the page (i.e. a discovery section, common ground section, discussion section, and event section) based on each advertising unit's type. Each section in FIG. 3A corresponds to a position in a sales funnel associated with the group of advertising units. By placing the advertising units in this manner, the ordering for the advertising units previously determined using the sales funnel can be communicated to the viewing user 110. It should be appreciated that other embodiments may have additional, fewer, or different sections corresponding to a sales funnel.

FIG. 3B illustrates an exemplary page including a group of ordered advertising units 190. As shown in FIG. 3B, the page includes a newsfeed story 305. The newsfeed story 305 describes a user activity of a friend 120 of the viewing user 110. In particular, the newsfeed story 305 indicates that the viewing user's friend Roger has watched the film <Comedy>Movie with Bob. FIG. 3B additionally shows three advertising sections: the discovery section 310, discussion section 315, and the event section 320. Each advertising section can correspond to a particular sales funnel position. In one embodiment, each of the sections can be adjacent to one another. In addition, at least one of the sections can be adjacent to the newsfeed story 305 that indicates the user activity that serves as the basis for the group of the advertising units. Each section can include advertising units classified as a certain type. For example, the discovery section 310 includes advertising units classified as the discovery type. Referring to discovery section 310, the section includes two advertising units. The first advertising indicates that a friend of the viewing user 110 likes <Comedy>Movie. The second advertising unit indicates that another friend of the viewing user likes a particular actor. The actor may be an actor featured in <Comedy>Movie. Referring now to discussion section 315, the section includes a single advertising unit. The advertising unit includes a movie trailer for <Comedy>Movie. The advertising unit additionally includes a text box configured to receive input from the viewing user 110. The input received from the viewing user can be responsive to the question presented by the advertising unit. Referring now to event section 320, the section includes an advertising unit that displays show times for <Comedy>Movie at a nearby cinema. The advertising unit additionally includes a link that enables the viewing user 110 to purchase tickets for <Comedy>Movie.

### Method for Providing Sponsored Stories

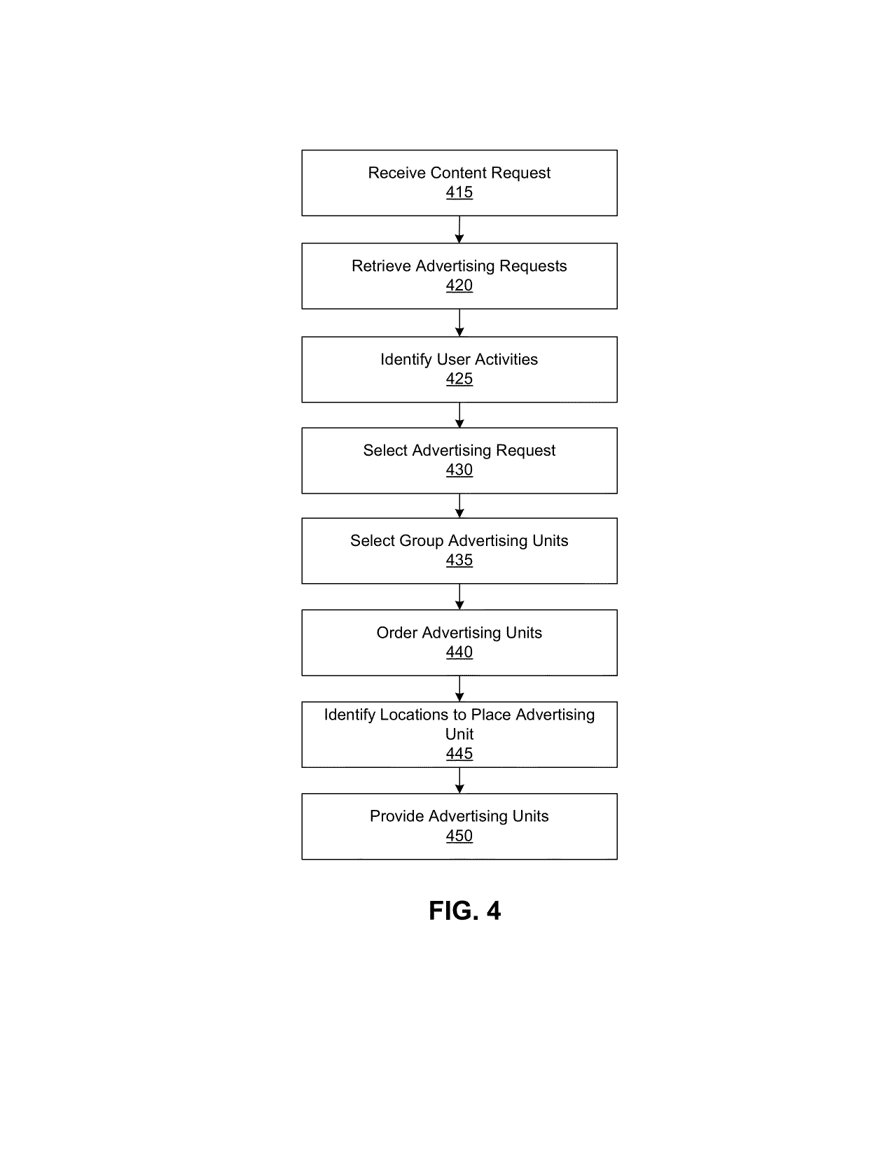

FIG. 4 illustrates one embodiment of a process for providing an ordered group of advertising units. In one embodiment, the process receives 415 a request for content from a viewing user 110, where the content is to be presented with an ordered group of advertising units. The process then retrieves 420 one or more advertising requests. The advertising requests can be retrieved from the advertising store 247. The process then identifies 425 the user activities performed by the viewing user 110 and his or friends 120. Based on the user activities, the process 430 selects a specific advertising request to serve as the basis for the ordered group of advertising units. The selected advertising request can specify a user activity performed by the viewing user 110 and/or his friends 120. Thereafter, the process selects 435 a group of advertising units related to the user activity specified by the selected advertising request. An advertising request can be related to a user activity if, for example, the advertising request is associated with a social networking objected involved in the user activity. After selecting the group of advertising units, the process orders 440 the advertising units. In particular, the process can order the group of advertising units based on a sales funnel. The sales funnel can indicate an ordering for the group of advertising units according to the type for each of the advertising units. The process then identifies 445 locations in a web page to place the advertising units, where the location for each advertising unit is based on the ordering. Thereafter, the process provides 450 the ordered group of advertising units for display to the viewing user 110. In one embodiment, the process additionally provides, for display to the viewing user 110, a story describing the user activity related to the ordered group of advertising units.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
identifying a first activity, the first activity being performed by at least one of a viewing user or a user connected to the viewing user;
generating a story based on the first activity, the story including content describing the first activity;
identifying a plurality of advertising units, wherein each of the plurality of advertising units is associated with the first activity;
classifying each of the advertising units in the plurality to a category of a sales funnel;
selecting one or more of the plurality of advertising units based at least in part on the classification;
ordering the selected one or more advertising units according to the classification; and
sending the story and the ordered advertising units for display to the viewing user.

2. The computer-implemented method of claim 1, wherein the selected advertising units are positioned on a page to be displayed to the viewing user, each selected advertising unit being positioned adjacent to another of the selected advertising units on the page, and at least one of the selected advertising units being positioned adjacent to the story on the page.

3. The computer-implemented method of claim 1, wherein determining the ordering includes:
ordering a first selected advertising unit having a first classification before advertising units having a second classification, a third classification, or a fourth classification, wherein the first selected advertising unit includes information determined to introduce content related to the first activity;
ordering a second selected advertising unit having the second classification before advertising units having the third classification or the fourth classification, wherein the second selected advertising unit includes content describing a second activity performed at least by the viewing user and a friend of the viewing user, wherein the second activity is related to the first activity;
ordering a third advertising unit having the third classification before advertising units having the fourth classification, wherein the third selected advertising unit includes an input element for enabling a viewing user to interact with the third advertising unit; and
ordering a fourth selected advertising having the fourth classification after advertising units having the first classification, the second classification or the third classification, wherein the fourth selected advertising unit includes information describing an event related to the first activity.

4. The computer-implemented method of claim 3, wherein information received from the viewing user via the input element of the third advertising unit is used to provide another story and selection of ordered advertising units to one or more other users connected to the viewing user.

5. The computer-implemented method of claim 1, wherein the ordering of the advertising units includes ordering the advertising units in descending order of specificity.

6. The computer-implemented method of claim 1, wherein at least one of the one or more selected advertising units is selected based at least in part on how recently the content included in the advertising unit was posted.

7. The computer-implemented method of claim 1, wherein at least one of the one or more selected advertising units is selected based at least in part on a user engagement value for the at least one advertising unit.

8. The computer-implemented method of claim 1, wherein at least one of the one or more selected advertising units is selected based at least in part on a friend coefficient associated with the at least one advertising unit.

9. The computer-implemented method of claim 1, wherein identifying the plurality of advertising units includes:
identifying a social networking object involved in the first activity; and
identifying advertising units that each includes content relevant to the social networking object.

10. A computer-implemented method comprising:
identifying a plurality of user activities, wherein each of the user activities is performed at least by a viewing user or a user connected to the viewing user;
identifying a plurality of candidate advertising requests, wherein each candidate advertising request specifies a user activity that corresponds to a user activity in the identified plurality of user activities;
selecting an advertising request from the plurality of candidate advertising requests;
generating a story describing the user activity specified in the selected advertising request;
identifying a plurality of advertising units, wherein each of the plurality of advertising units is related to the user activity specified in the selected advertising request;
determining an order for the plurality of advertising units based on a position in a sales funnel for each of the plurality of advertising units, wherein the position of each advertising unit in the sales funnel is based on a sales funnel type for the advertising unit; and
sending the story and the plurality of advertising units to a client device, wherein the client device displays the story and the plurality of advertising units to the viewing user based on the determined order for the plurality of advertising units.

11. The computer-implemented method of claim 10, wherein the plurality of advertising units are displayed on a web page presented to the viewing user, wherein each of the plurality of advertising units is adjacent to another of the plurality of advertising units in the web page.

12. The computer-implemented method of claim 10, wherein selecting the advertising request includes determining whether a user activity specified by the advertising request is related to a set of advertising units that meets each of a plurality of threshold numbers required by the sales funnel.

13. The computer-implemented method of claim 12, wherein determining whether the user activity specified by the advertising request is related to a set of advertising units that meets the plurality of threshold numbers includes:
identifying a sales funnel type for each of the advertising units in the set;
determining, for each sales funnel type, a number of advertising units in the set having the sales funnel type; and
determining, for each sales funnel type, whether the number of advertising units in the set having the sales funnel type meets a corresponding threshold number from the plurality of threshold numbers.

14. A computer-implemented method comprising:
selecting a plurality of advertising units related to an item of social networking system content;
assigning each of the plurality of advertising units to a particular category of a sales funnel;
ordering the plurality of advertising units based on the assignment; and
sending the plurality of advertising units for display to the viewing user, wherein the plurality of advertising units is positioned based on the ordering.

15. The computer-implemented method of claim 14, wherein the social networking system content includes user profile information associated with a profile of the viewing user, wherein the plurality of advertising units is related to the user profile information.

16. The computer-implemented method of claim 14, wherein the social networking system content includes a newsfeed story describing a user interaction performed by at least one of the viewing user or a user connected to the viewing user, wherein the plurality of advertising units is related to the newsfeed story.

17. The computer-implemented method of claim 16, further comprising sending the newsfeed story for display to the viewing user, wherein the newsfeed story is positioned adjacent to at least one of the plurality of advertising units.

18. The computer-implemented method of claim 14, wherein at least one of the selected advertising units includes purchase information for an item, wherein the item is relevant to the social networking system content.

19. The computer-implemented method of claim 14, wherein:
a first subset of the plurality of advertising units is assigned to a first category of the sales funnel, each advertising unit in the first subset including information describing content related to the social networking system content;
a second subset of the plurality of advertising units is assigned to a second category of the sales funnel, each advertising unit in the second subset including an input element related to the social networking content; and
a third subset of the plurality of advertising units is assigned to a third category of the sales funnel, each advertising unit in the third subset including event information related to the social networking system content.

20. The computer-implemented method of claim 19, wherein ordering the plurality advertising units based on the assignments includes:
ordering the first subset of the plurality of advertising units before the second and third subsets; and
ordering the second subset before the third subset.
